(19) United States
(12) Patent Application Publication
(10) Pub. No.: US 2014/0221187 A1
(43) Pub. Date: Aug. 7, 2014

(54) Centrifuge

(71) Applicants: Julian König, Paderborn (DE); Verena Tiggemann, Ennigerloh (DE); Sarah Ossenbrink, Herzebrock-Clarholz (DE)

(72) Inventors: Julian König, Paderborn (DE); Verena Tiggemann, Ennigerloh (DE); Sarah Ossenbrink, Herzebrock-Clarholz (DE)

(73) Assignee: GEA MECHANICAL EQUIPMENT GmbH, Oelde (DE)

(21) Appl. No.: 14/110,858

(22) PCT Filed: Apr. 17, 2012
(86) PCT No.: PCT/EP2012/056975

§ 371 Date: Feb. 5, 2014

(30) Foreign Application Priority Data
May 2, 2011 (DE) 10 2011 050 046.4

(51) Int. Cl. B04B 1/08

(52) U.S. Cl. CPC B04B 1/08
USPC 494/70

(57) ABSTRACT

The invention relates to a centrifuge having a centrifugal drum in which separator disks are disposed, and at least one of the separator disks includes surface structuring that improves separator performance.

### FIELD AND BACKGROUND OF THE INVENTION

The invention relates to a centrifuge having a centrifugal drum in which separator disks are disposed.

A centrifuge having a separator-disk packet is disclosed, for example, in DE 10 2008 051 867 A1. Separator disks are normally made of metal. Additionally known, from EP 644 121 B1, are separator disks for a centrifuge that have a polyfluorinated coating.

Usually, there are joint pieces, in the form of webs or spots, realized on a separator disk.

The prior art additionally includes EP 0 320 105 A1, in which it is proposed to provide the separator disks with flow influencing parts that are attached to the surface of the top side of the separator disk. These parts perform the function of preventing a so-called Ekman layer on the separator disk. For this purpose the flow influencing parts have a square shape. Although there is an increased deposition of solids on such a surface structuring of a separator disk, the flow influencing parts nevertheless impede transport of particles on the separator disk in the direction of the joint pieces. The flow influencing parts also impede the flow of the liquid to be clarified. As a result, the liquid may be remixed with the solid particles deposited on the flow influencing parts.

### SUMMARY OF THE INVENTION

It is therefore the object of the invention to reduce the remixing of solid particles and liquid on a separator disk.

According to the invention, a centrifuge, in particular a separator or a solid-bowl screw-type centrifuge, has a centrifugal drum, in which there is disposed a separator-disk packet of stacked conical separator disks that have a separator-disk top side and a separator-disk underside, and at least one or more of the separator disks have a surface structuring on the separator-disk underside, at least in some regions, for transport of particles.

Since particles can collect on the surface structuring and then be guided by the surface structuring on the separator disk, remixing is reduced, i.e. the radial transport of already deposited particles, in the direction of the rotation axis, with the liquid to be clarified.

Solid particles can be carried, or transported, on the separator disk in various ways. For this, it has proved advantageous to realize the surface structuring as micro-flutes, which are preferably disposed obliquely, in an arcuate manner or in a herringbone pattern on a disk segment.

For the purpose of collecting solid particles, micro-flutes preferably have a flute width of between 0.1 and 500 μm, particularly preferably between 10 and 150 μm. They have a flute depth of 0.1-250 μm, preferably between 10 and 100 μm. Individual micro-flues in this case are preferably parallel to each other, and are preferably spaced apart from the adjacent micro-flute by a distance of 0.05 mm-50 mm.

Particularly preferably, solid particles are preferably filled in the radial direction, for example toward a joint piece or the disk edge, provided that the micro-flutes extend at an angle of 40-60° in relation to a radial of the surface structuring or in relation to the joint pieces.

It is advantageous if the thickness of the surface structuring on the separator disk increases in the radial direction, as far as the outer disk edge. This makes it possible, for example, for solid particles that are deposited in the region of the outer disk edge to be received by deeper micro-flutes, while smaller solid particles that are deposed in a disk region closer to the inner disk edge are received by flatter micro-flutes.

The separator disk can additionally have an abrasion-resistant coating, in which the surface structuring is realized. It is particularly advantageous if the coating is a paint that, in addition to guiding the solid particles, also enables the surface tension to be reduced. As a result, the particles can slide better on the surface of the separator disk, and consequently be removed even more rapidly from the surface of the separator disk.

The surface structuring can also be effected by an engraving, for example by impressing with a punch or rolling-in with a roller or, preferably, by a laser engraving. The laser-induced removal of material of the coating or of the separator-disk material on the separator-disk underside can vary in dependence on the intensity of the laser beam. The depth of penetration, or the thickness of the surface structuring, can thus be modulated, for example, in the radial direction. Laser engraving in this case also makes it possible to realize a surface structuring on ceramic or glass-type coatings and also, in particular, on particularly abrasion-resistant coatings of hard material.

In order to prevent clogging, and in order not to excessively impede the flow of liquid, it is advantageous if the maximum height of the micro-flutes is one sixth of the distance of the separator disk from an adjacent separator disk, i.e. of the so-called disk gap.

Joint pieces, in the form of spots or webs, are used to space the disks apart from each other. These joint pieces, which are preferably realized as webs, can additionally be used to deflect the solids in the radial direction.

In this case, a joint piece, in combination with the separator disk, can realize an oblong channel that advantageously enables the solids to be deflected in the radial direction. The realization of a channel between the separator-disk surface and the joint piece additionally prevents the collected solids from being remixed with the liquid guided past and, at the same time, improved agglomeration of solids is achieved, owing to the high concentration of solids in the channel.

For the purpose of delivering solids into the channel, it is advantageous if the joint pieces are realized on a first side on a disk region. Since the smooth surface of the joint piece is supported on the uneven surface structuring, through-openings, through which the solids pass into the channel, are created because of the irregularities, for example in the region of micro-flute troughs. This is advantageous, since there is therefore no need to make additional inlet holes in the joint piece.

In order to promote removal within the channel, the cross section of the channel increases in the radial direction, i.e. toward the outer disk edge. Moreover, the inner wall of the channel does not have any surface structuring.

For the purpose of better receiving solids in the channel, the separator disk has an oblong depression along the channel. This oblong depression serves, inter alia, to prevent clogging of the through-openings into the channel.

The invention is described in greater detail in the following with reference to the drawing, on the basis of a plurality of exemplary embodiments.

### BRIEF DESCRIPTION OF THE DRAWINGS

FIG. 1 shows a perspective view of a schematically represented separator disk;

FIG. 2 shows an illustration of the principle of a nozzle separator that is suitable for using separator disk;

FIG. 3 shows a schematic view of a separator disk from below;

FIGS. 4-7 show a schematic representation of portions of further separator disks having differing surface structurings;

FIG. 8 shows a schematic representation of portions of a separator disk having double joint pieces; and

FIGS. 9a- c show enlarged sectional views of separator disks having differing shapes of the joint pieces.

### DETAILED DESCRIPTION OF THE PREFERRED EMBODIMENTS

FIG. 2 shows a centrifuge realized as a separator, in this case a nozzle separator, having a centrifugal drum 1, which is rotatable about a rotation axis D and in which there is inserted, respectively, a separator-disk packet 2 of separator disks 3,3′ that are disposed over one another, or stacked. The functioning of such separators, having an inlet 4, a solids space 5 and outlets 6, 7 have been generally known for a long time, and therefore do not require more detailed explanation. The rotation axis D in this case is aligned vertically, and the drum is in the form of a double cone.

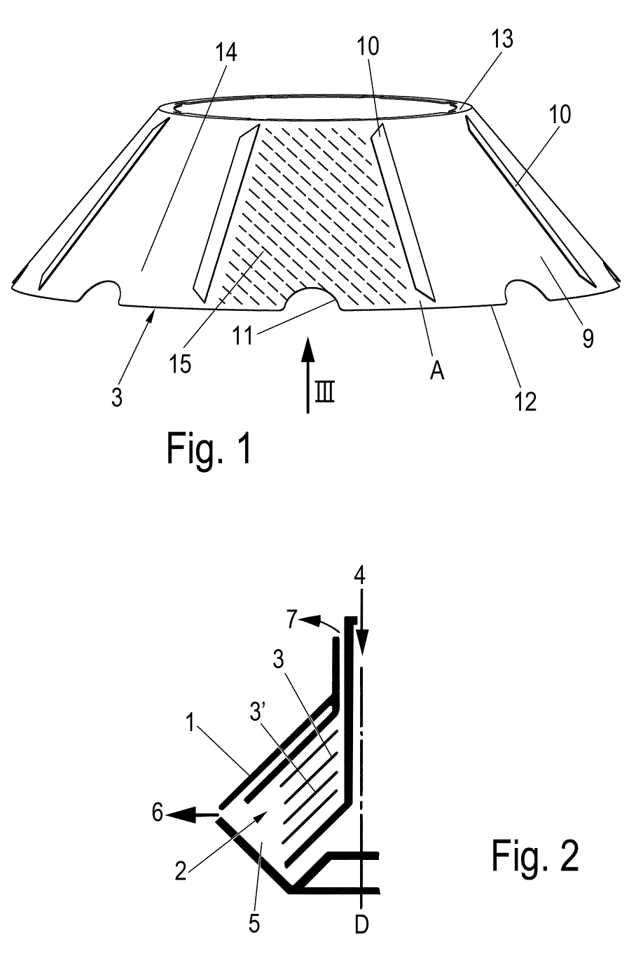

FIG. 1 shows a schematic representation of a separator disk 3 according to the invention, which is preferably composed of a metal plate.

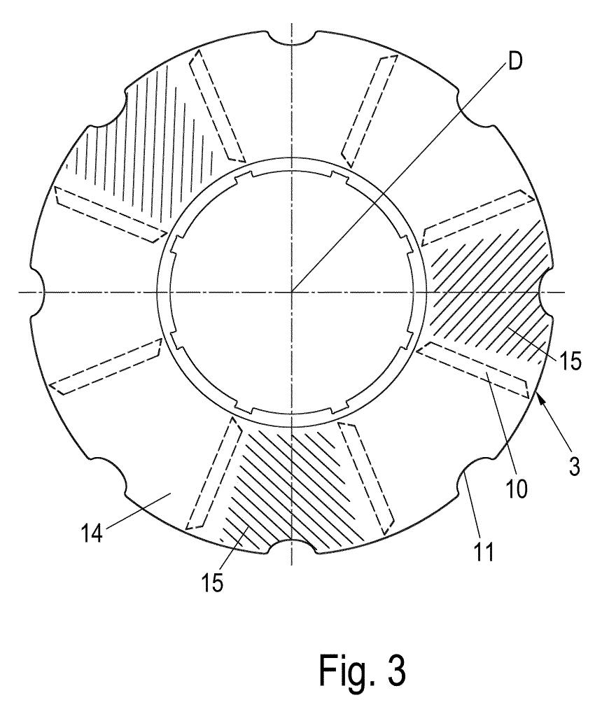

The separator disk 3 can in each case have openings or recesses 11 (see FIG. 3) that, in combination with further separator disks 3′, constitute a vertical channel when in the mounted state. The separator disks 3 and 3′ are axially spaced apart from each other, such that a gap, a so-called disk gap, is realized between them in each case.

The separator disk 3 has a conical basic shape 9 (see FIG. 1), such that a sequence of a plurality of separator disks 3, 3′ also realizes a substantially conical separator-disk packet 2. The separator disk 3 in this case has an outer disk edge 12 and an inner disk edge 13, the outer disk edge 12 having a greater circumference than the inner disk edge 13.

On the conical basic shape 9 of the separator disk 3, protrusions are realized by joint pieces. These joint pieces serve as spacers and influence the flow, and are realized, for example, as web joint pieces or spot joint pieces. So-called web joint pieces 10 are realized on the separator disk 3, for example attached thereto or impressed therein. The separator disk 3 additionally has recesses 11 in the region of the outer disk edge 12.

The web joint pieces 10 divide the separator disk 3 into separator-disk segments 14. On these separator-disk segments 14, solids are separated out from a liquid to be clarified. For the purpose of deflecting the solid particles in a targeted manner in the direction of the web joint pieces 10 of the adjacent separator disk and, in particular, in order to prevent remixing of the solids, one or more disk segments 14 on the disk underside has a surface structuring, in this case in the form of micro-flutes 15.

In FIG. 1, these micro-flues 15 are stamped into the inwardly oriented surfaces of a separator disk 3. The micro-flutes in this case are preferably parallel to each other.

The surface structuring has the effect of reducing the remixing of the solids deposited in the flutes and, on the other hand, of helping to guide, or transport, the solid particles in the direction of the web joint pieces 10 of the adjacent separator disk.

The solid particles collect on the web joint pieces 10 and are routed radially along a web joint piece 10, to the outer circumference of the disk 3, or to the outer disk edge 13, from where they slide off into the solids space 5 of the centrifuge. The guidance of the solid particles by means of the micro-flutes 15 advantageously reduces remixing of these particles on the disk segment 14, and shortens the critical time in which such a particle slides off into the counterflow.

At the same time, owing to the improved transport of solids by the surface structuring, solid particles agglomerate on the web joint pieces 10, because of their increased concentration in this region. After the particles have been transported by the web joint pieces to the radial outer circumference of the separator disk 3, they slide off, at a predetermined location A, into the solids space 5 of the centrifuge. Since this sliding-off of the particles into the solids space now occurs to a greater extent at the predetermined location A, there is a reduction in the extent to which the particles are taken up again by the liquid flowing into the disk gap between the disks 3 and 3′ and also, consequently, an increase in the separating efficiency of the centrifuge.

FIG. 2 shows a schematic representation of a disk separator.

FIG. 3 shows the separator disk 3 from below, i.e. in the direction of view III of FIG. 1, on which the web joint pieces 10 are disposed in the radial direction in relation to the rotation axis D. These web joint pieces divide the separator disk 3 into a total of eight separator-disk segments 14, which each have the surface structuring, in the form of micro-flutes 15, already described in FIG. 1.

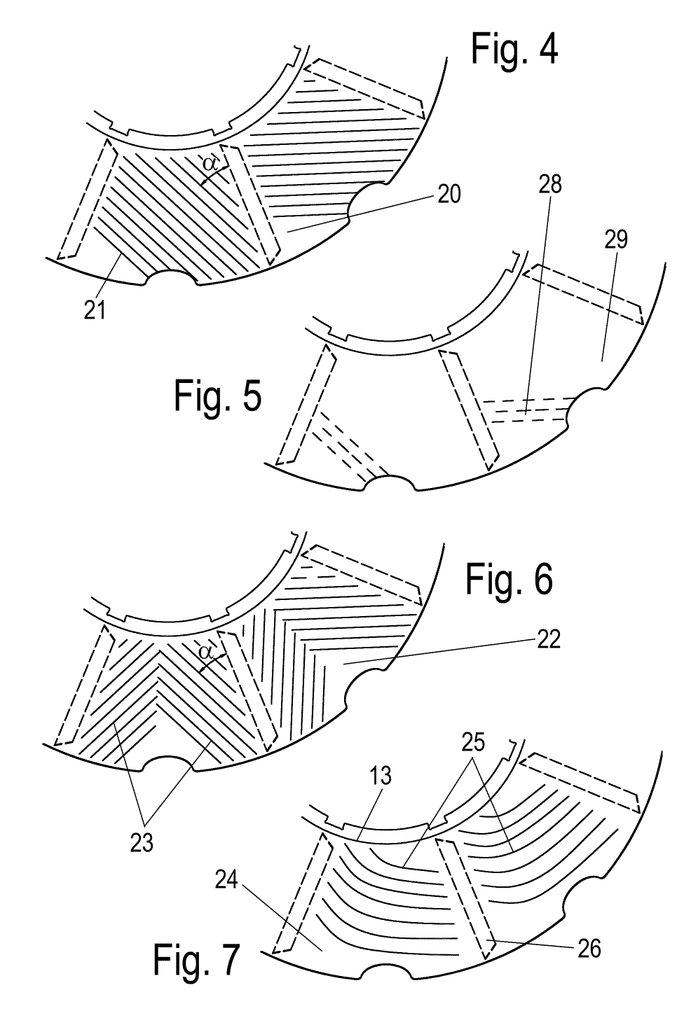

It is particularly advantageous if the micro-flutes 15, as also shown, for example, in FIG. 4, extend at an angle a of 40-90° in relation to the radial of the surface structuring, or extend in an arcuate manner toward the web joint pieces 10. In a preferred exemplary embodiment, the angle of the micro-flutes in relation to the radial of the surface structuring is constant, such that the micro-flutes as a whole are disposed in an arcuate manner along the disk segment, and extend almost linearly along the disk segment 15 in the plan view of FIG. 3.

If the angle α=90°, the micro-flutes being parallel to the tangent to the inner and outer disk edge, this advantageously makes it more difficult for solid particles to be entrained inwardly, in the radial direction, in the liquid flow.

Further advantageous surface structurings are represented schematically in FIGS. 4-7.

The distance between the micro-flutes in this case is preferably 0.05 mm-50 mm, particularly preferably 0.5-5 mm. The micro-flutes are preferably parallel to each other.

FIG. 4 shows a portion of a separator disk having a plurality of micro-flutes 21 that, like the micro-flutes from FIG. 3, extend preferably at an averaged angle α of 40-90° in relation to the radial on the underside of a disk segment 20.

FIG. 5 shows a portion of a separator disk having partially interrupted micro-flutes 28 that are realized on the underside of a disk segment 29.

FIG. 6 illustrates a herringbone pattern of micro-flutes 23, i.e. a pattern of oppositely oriented micro-flutes, which are disposed at an angle of preferably 40-60° in relation to the radial on the underside of a disk segment 22. The micro-flutes 23 can also be disposed, for example, with mirror symmetry in relation to each other.

FIG. 7 shows an arcuate arrangement of the micro-flutes 25, wherein the shape of the arcs results of a constant angle between the tangential of the arc and the radial to the rotation axis. This angle is preferably 40-70°.

In order, advantageously, to prevent transport clogging, the difference between protrusions and depressions in the surface structuring should preferably be not more than one sixth of the height of the disk gap. The height of the micro-flutes on a separator disk can vary in this case. Thus, the flute height can increase with the concentration of solids or with an increasing diameter of the separator disk.

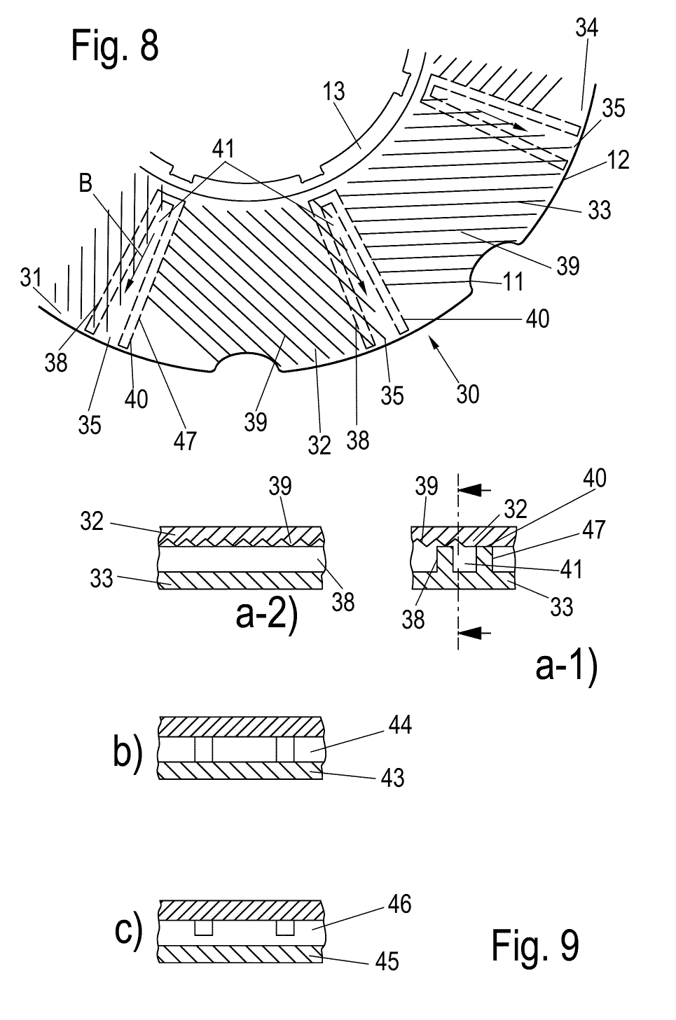

FIG. 8 shows a portion of a separator disk 30 having a total of four successive separator-disk segments 31, 32, and 34. Realized on the top side of the separator disk 30 are a plurality of double joint pieces 35 that divide the conical separator disk 30 into the said separator-disk segments.

The double joint pieces 35 are fixed, on a first side 38, to the surface structuring 39 of the said separator-disk segments. The fixing can be effected, for example, by spot welding. On the opposite, second side 47 of the double joint piece 35, the latter is fixed to a flat surface portion 40 of the succeeding separator-disk segment, as also represented in greater detail, for example, in FIG. 9a-1. Owing to this arrangement, a channel 41 is formed in the double joint piece 35. This channel is open on the first side 38, or has through-openings, such that solids can be transported into the channel 41. These solids pass through the irregularities of the surface structuring 39 into the channel 41 and are transported inside the channel 41, in the radial direction B, to the outer disk edge 12. In order not to impede the transport of particles inside the channel 41, no surface structuring is provided on the adjoining separator disk in this region. Advantageously in this case, remixing is virtually precluded.

The receiving capacity of the channel 41 in this case can be additionally increased, in that an oblong depression is made in the separator disk, in the region covered by the double joint piece.

The channel 41 increases in diameter in the radial direction B, in order thus to prevent clogging with solids.

It is additionally advantageous if the channel 41 extends as far as the outer disk edge 12, such that the solids can be discharged directly into the solids space 5. In this way, remixing on emergence from the channel is advantageously prevented.

FIGS. 9a-c show, by way of example, various designs of a permeable joint piece with a channel, the side 38, 44 or 46 of a corresponding joint piece differing in design, in particular in respect of the through-openings into a corresponding channel 41.

A surface structuring can be realized in various ways. Thus, the surface structuring can be scored in, for example by means of a suitable appliance, or applied by a suitable planishing roller that is itself fluted, for example, along the circumference. Alternatively, the surface structuring can be created by a punch, before or during the planishing of the separator disk. The punch in this case should itself be composed of a harder material than the separator disk, for example of tungsten carbide.

The surface structuring can therefore also be realized by stamping and/or rolling-in the surface structuring.

Alternatively, the surface structuring can also be created by laser treatment. In this case, a laser removes the material from the separator-disk surface and thereby produces micro-flutes.

Finally, a coating can also be applied to the disk surface by a paint dispersion, for example as a stoving paint, and a surface structuring can be applied by mechanical treatment. The paint layer is then hardened, for example by a stoving operation. Particularly suitable in this case are paints and coatings composed, for example, of polyfluorinated hydrocarbon compounds that, owing to low coefficients of friction, additionally reduce the surface tension on the interface between the solid and the disk material and thereby additionally promote the transport of particles on to a web joint piece or into the channel of a double joint piece. Ceramic coatings of a separator disk are also possible, in principle, for a surface structuring.

1. A centrifuge comprising:
a centrifugal drum; and
a plurality of stacked conical separator disks disposed in the centrifugal drum, and each separator disk has a top side and an underside, and at least one of the separator disks includes a surface structuring on the separator-disk underside.

2. The centrifuge of claim 1, wherein the separator disk surface structuring is arranged to transport particles to an outlet location on the separator disk.

3. The centrifuge of claim 1, wherein the surface structuring includes micro-flutes on the separator-disk underside.

4. The centrifuge of claim 1, wherein the surface structuring is disposed obliquely in relation to a radial direction on the separator disk.

5. The centrifuge of claim 1, wherein the surface structuring extends at an angle of between 40° and 90° in relation to a radial direction of the separator disk.

6. The centrifuge of claim 1, wherein a depth of the surface structuring on the separator disk underside increases in a radial direction toward an outer disk edge.

7. The centrifuge of claim 1, wherein the separator disk underside includes a coating that defines the surface structuring.

8. The centrifuge of claim 7, wherein the coating is a paint for reducing the surface tension of a fluid in the centrifuge.

9. The centrifuge of claim 1, wherein the surface structuring is an engraving.

10. The centrifuge of claim 1, wherein the surface structuring has a maximum height that is no greater than one sixth of a distance between one separator disk and an adjacent separator disk.

11. The centrifuge of claim 1, and further comprising:
a plurality of spaced apart joint pieces joined to a separator disk.

12. The centrifuge of claim 1, and further comprising:
a plurality of spaced apart joint pieces joined to the separator disk, and each of the joint pieces is a web.

13. The centrifuge of claim 1, and further comprising: a joint piece joined to the separator disk to at least partially define an oblong channel.

14. The centrifuge of claim 1, and further comprising:
a plurality of spaced apart joint pieces joined to a top side of a separator disk.

15. The centrifuge of claim 1, and further comprising:
a joint piece joined to a top side of a separator disk and the joint piece defines a channel with a cross-section that increases in a radial direction.

16. The centrifuge of claim 1, and further comprising:
a joint piece joined to a top side of a separator disk and the joint piece defines a channel with an inner wall, which does not have any surface structuring.

17. The centrifuge of claim 1, and further comprising:
a joint piece joined to a top side of a separator disk and the joint piece defines a channel that has an oblong depression along the channel.

18. The centrifuge of claim 1, wherein the separator disk is composed of a steel plate.

19. The centrifuge of claim 1, wherein the surface structuring is disposed in an arcuate manner in relation to a radial direction on a separator disk.

20. The centrifuge of claim 1, wherein the surface structuring is disposed in a herringbone pattern.
